(19) United States
(12) Patent Application Publication
(10) Pub. No.: US 2007/0139396 A1
(43) Pub. Date: Jun. 21, 2007

(54) Electronic apparatus having pointing device

(75) Inventors: Masaki Kanayama, Kawasaki (JP); Mitsuhiko Kawami, Kawasaki (JP); Hisao Morooka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/706,981

(22) Filed: Feb. 16, 2007

Related U.S. Application Data
(63) Continuation of application No. PCT/JP04/11912, filed on Aug. 19, 2004.

(51) Int. Cl. G09G 5/00

(52) U.S. Cl. 345/173

(57) ABSTRACT

An electronic apparatus includes a body, and a display that displays information and is foldable over the body, a pointing device that designates an input position and coordinate on the display, and a lock mechanism that locks the display that has been folded over the body, part of the lock mechanism being formed in the pointing device.

This application is a continuation based on International Patent Application No. PCT/JP2004/011912, filed on Aug. 19, 2004, which is hereby incorporated by reference herein in its entirety as if fully set forth herein.

### BACKGROUND OF THE INVENTION

The present invention relates generally to an electronic apparatus having a pointing device, and more particularly to a foldable and portable electronic apparatus having a touch-pad type pointing device. The “portable electronic apparatus” covers, for example, a laptop or notebook-type personal computer (“PC”), a personal digital assistant (“PDA”), an electronic dictionary, electronic stationary, a game machine, and a portable home appliance (such as a portable TV, a portable videocassette recorder, and a portable DVD). The present invention is suitable, for example, for a touch-pad type pointing device in a laptop PC.

Recently, a demand for a smaller and user-friendlier laptop PC has increasingly grown. A pointing device having a pair of click buttons has conventionally been proposed for this laptop PC, and is used to move a pointer on a display with such a means as a pad, a stick and a ball. A touch pad is one input device among them, detects movements of a user's finger on a square with several-centimeter sides, and moves the pointer in accordance with a moving direction and a moving amount. The touch pad is widely used for many laptop PCs due to its advantages in almost unnecessary maintenance and its small device thickness.

The laptop PC having the touch-panel type pointing device usually arranges the touch pad in front of the keyboard (closer to the user than the keyboard), and a click button in front of the touch pad. Since the pointing device needs to be squeezed in an area determined by the display size, a space for the pointing device is first secured and then the keyboard is arranged in the remaining space.

Some laptop PCs have a mechanism that locks the display and the PC body when the laptop PC is folded. The lock mechanism typically has an engaged part at the display side, an engagement hole in the PC body, into which the engaged part is inserted, an engaging part engageable with and disengageable from the engaged part in the engagement hole, a moving mechanism that enables engaging part to move in such a manner that the engaging and engaged parts can be engaged with and disengaged from each other. In this case, the engagement hole is provided at a central forefront of the PC body, which is located in front of the click button of the pointing device.

Other prior art include, for example, Japanese Patent Applications, Publication Nos. 2000-20162, 2000-222118, and 4-276814.

The laptop PC having the conventional touch-panel type pointing device arranges the keyboard near the display for the pointing device and the lock mechanism. However, the keyboard becomes ergonomically user-friendlier as located as far from the display as possible. The keyboard when arranged further forward (closer to the user) would make the click buttons and the touch pad smaller, deteriorating the operability of the pointing device. Thus, the conventional laptop PC cannot reconcile the operability of the keyboard with the operability of the pointing device, and does not have sufficient information input operability.

### BRIEF SUMMARY OF THE INVENTION

Accordingly, it is an exemplary object of the present invention to provide an electronic apparatus having a pointing device with good information input operability.

An electronic apparatus according to one aspect of the present invention includes a body, and a display that displays information and is foldable over the body, a pointing device that designates an input position and coordinate on the display, and a lock mechanism that locks the display that has been folded over the body, part of the lock mechanism being formed in the pointing device. This electronic apparatus, such as a laptop PC, arranges the lock mechanism in the pointing device, saving the mounting space and making the electronic apparatus smaller, rather than arranging them at separate positions.

For example, the pointing device includes an operation button, and the lock mechanism includes a first engaging part provided on the display, an engagement hole formed in the operation button in the body and, the first engaging part being inserted into the engagement hole; and a second engaging part configured to be engageable with and disengageable from the first engaging part that is inserted into the engagement hole. The lock mechanism may further include a release button, coupled to the operation button, which moves the second engaging part for a disengagement from the first engaging part that is inserted into the engagement hole.

Preferably, the pointing device includes a pair of operation buttons, and a wheel, such as of a roller type, which is arranged between the pair of operation buttons. This configuration can make the electronic apparatus small, and enhance the operability of the pointing device. The pointing device may further include a substrate having a notch in which the first and second engaging parts are arranged. The notch enables the lock mechanism and the pointing device to be integrated.

An electronic apparatus according to another aspect of the present invention includes a body, and a display that displays information and is foldable over the body, and a pointing device that designates an input position and coordinate on the display, and includes an operation button that is formed at a front edge as a corner of the body opposite to the display, the operation button at least partially exposing while the display is folded. That the operation button partially exposes means that the front edge extends from the top surface of the body (which is unseen when the display is folded) to the front surface of the body. The front edge is formed at the corner, and secures the surface area of the operation button as well as reducing the area of the pointing device on the body. The pointing device (or the operation button) is usually provided at the front edge of the body so that the center of the front edge, the center of the home position of the keyboard, and the center of the pointing device in the width direction are aligned with each other. However, the present invention allows the pointing device (or the operation button) to be provided on the center front edge of the body.

Preferably, the pointing device includes a pair of operation buttons, and a wheel, such as of a roller type, which is arranged between the pair of operation buttons, the wheel being formed on the front edge, and at least partially exposing while the display is folded. Preferably, the front edge has a curved shape or an inclined surface facing in an upper oblique direction. Such a surface increases an area that enables the user to obliquely view the front edge, improving the operability. The roller-type wheel facilitates such a curved surface, and prevents malfunction as a result of that it is projected and erroneously caught by the user.

Preferably, the pointing device further includes a touch pad between the operation button and the display, and the electronic apparatus further includes a keyboard between the touch pad and the display. This configuration can reconcile the operability of the keyboard with the operability of the pointing device. The touch pad has an advantage in almost unnecessary maintenance and miniaturization of the device, is superior to other pointing devices, such as a trackball and a stick, and contributes to the low profile of the electronic apparatus. A power button may be provided in a space between the keyboard and the display so as to maximize the space.

Other objects and further features of the present invention will become readily apparent from the following description of the preferred embodiments with reference to accompanying drawings.

### BRIEF DESCRIPTION OF THE DRAWINGS

FIG. 1 is a perspective overview of an electronic apparatus (laptop PC) according to the present invention.

FIG. 2 is a partially enlarged perspective view of the electronic apparatus shown in FIG. 1.

FIG. 3 is a partially exploded perspective view of the electronic apparatus shown in FIG. 1.

FIG. 4 is a partial plane view of the electronic apparatus shown in FIG. 1.

FIG. 5 is a sectional view taken along a line A-A shown in FIG. 4.

FIG. 6 is a sectional view taken along a line B-B shown in FIG. 4.

FIG. 7 is a partially enlarged perspective view showing a variation of an engaging part attached to an LCD bezel frame of the electronic apparatus shown in FIG. 1.

### DETAILED DESCRIPTION OF THE PREFERRED EMBODIMENTS

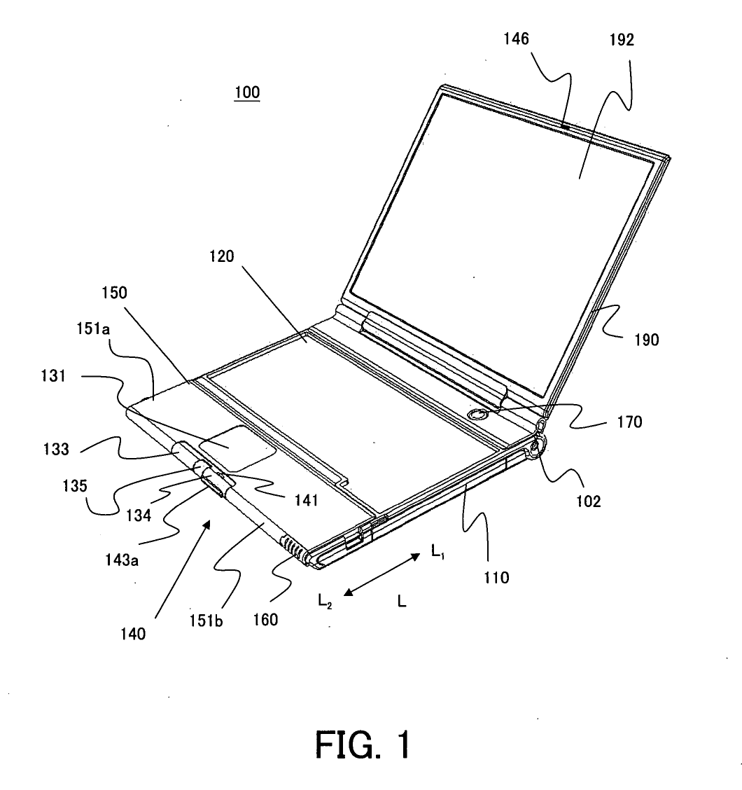

Referring to the accompanying drawings, a description will be given of an inventive electronic apparatus 100 that is implemented as a laptop PC. Here, FIG. 1 is a perspective overview of the laptop PC 100. Referring to FIG. 1, the electronic apparatus 100 is exemplarily embodied, but not limited to, as a laptop PC 100, and is applicable to a portable electronic apparatus having a pointing device. The size of the laptop PC 100 covers A4 size, B5 size, and other sub-note and mini-note size. The laptop PC 100 includes a base (or a lower housing) 110 as a PC body, and a liquid crystal display (“LCD”) bezel frame (or an upper housing) 190, which are connected by a hinge 102.

The base 110 has a thickness, for example, of about 20 to 30 mm, and includes a keyboard 120 for information typing, a pointing device 130, a lock mechanism 140, a palm rest 150, a battery residue display 160, and a power button 170.

Types of the keyboard 120 may include 101, 106, 109 and ergonomics, and key arrangements include QWERTY, DVORAK, JIS, new-JIS, and NICOLA (Nihongo Nyuryoku Conthotium Layout).

The keyboard 120 is located farther from the LCD bezel frame 190 than the conventional one by a predetermined distance. The predetermined distance corresponds to a shortened length in an L direction of the palm rest 150, as discussed later. Since the keyboard 120 is spaced from an LCD screen 192 of the LCD bezel frame 190, the screen and the user's fingers are spaced from each other by that distance, and the keyboard operability improves.

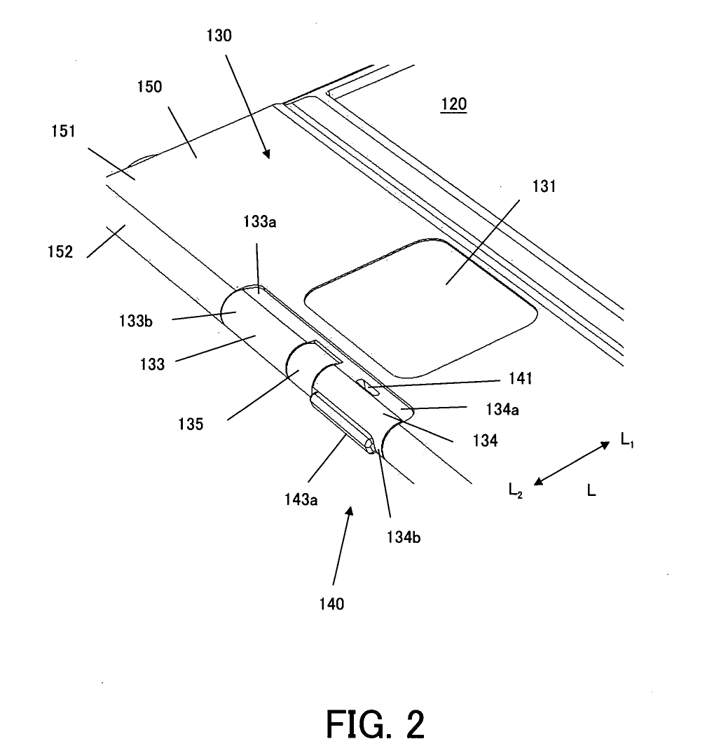

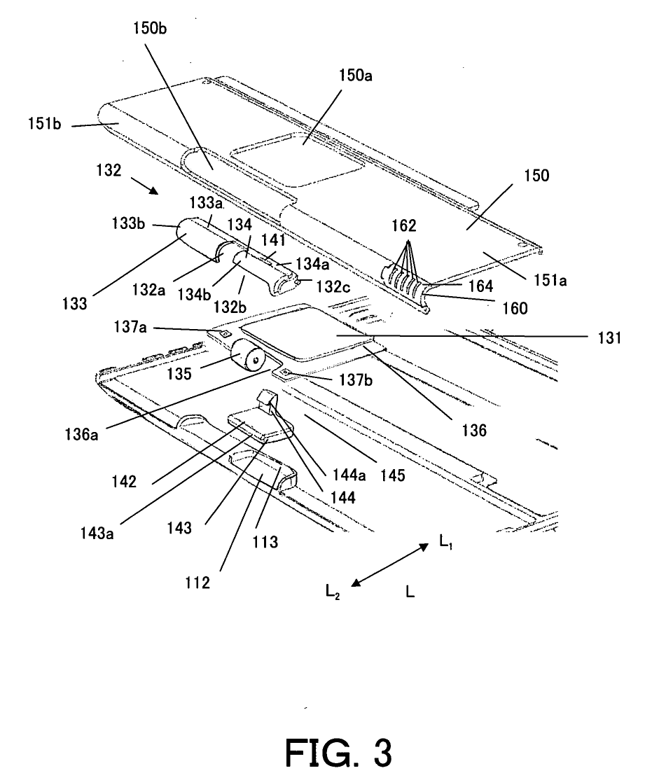

The pointing device 130 emulates the mouse functions, as shown in FIGS. 2 and 3, and includes a touch pad 131, a block 132, a roll-type scroll wheel 135, and a pointing-device substrate 136. Here, FIG. 2 is a partially enlarged perspective view of FIG. 1. FIG. 3 is a partially enlarged exploded perspective view of FIG. 1.

The touch panel 131 is connected to the pointing-device substrate 136, as shown in FIG. 3, and exposes through a rectangular hole 150a that is formed in a top surface part 151a of the palm rest 150. The user moves his finger on the touch pad 131, implementing a control function of moving a mouse cursor on the LCD screen 192. The pointing device 130 uses the touch pad 131 as large as the conventional one, and maintains the operability of the touch pad 131.

The block 132 defines, as shown in FIG. 3, left and right click buttons 133 and 134 that serve as operation buttons, and exposes through an attachment hole 150b in a forefront 151b that extends from the top surface to the front surface of the palm rest 150. The block 132 has a center hole 132a, a notch 132b, and a pair of projections 132c.

A scroll wheel 135 is inserted into the center hole 132a. A release button 143a of the lock mechanism 140 fits the notch 132. The projections 132c are provided at both sides of the block 132, and click buttons 133a and 134 are attached via a pair of projection 132c so that they can incline relative to the palm rest 150. The pointing device 130 is provided with a forcing member, such as a compression spring (not shown), which resets each of click buttons 133 and 134 of the block 132 to the horizontal state (non-inclined state).

The click button 133 has a function similar to a left click button of a universal mouse, and the right click button 134 has a function similar to a right click button of the mouse. The click button 133 has a flat part 133a and a curved part 133b, and the click button 134 has a flat part 134a and a curved part 134b. The flat parts 133a and 134a are arranged on the top surface part 151a of the palm rest 150, and hidden from the outside when the LCD bezel frame 190 is folded over the base 110. On the other hand, the curved parts 133b and 134b are arranged at the forefront 151b of the palm rest 150 and expose to the outside, even if the LCD bezel frame 190 is folded over the base 110. As described later, the flat part 134a has a hook hole 141.

The click buttons 133 and 134 have the curved parts 133b and 134b, and are arranged at the forefront 151b of the palm rest 150, which extends from the top surface to the front surface. When the inventive flat parts 133a and 134 are compared with the conventional click button that is arranged only on the top surface of the palm rest, a region of the click button is shorter on the top surface of the palm rest 150 in the length or L direction of the base 110. Since the keyboard 120 can be spaced from the LCD screen 192 of the LCD bezel frame 190 by that length, while the conventional size of the keyboard 120 is maintained. Since the keyboard 120 is spaced from the LCD screen 192 of the LCD bezel frame 190, the user's fingers are separated from the screen by that distance, and the operability of the keyboard improves.

On the other hand, when the click buttons 133 and 134 have only the flat parts 133a and 134a, the operability lowers due to the decreased operational area size. This embodiment provides the click buttons 133 and 134 with the curved parts 133b and 134b, and maintains the conventional surface areas of the click buttons, maintaining the operability.

The scroll wheel 135 emulates a mouse scroll wheel, and is provided in the center hole 132a. Since the scroll wheel 135 is provided in addition to the click buttons 133 and 134, the operability of the pointing device 130 improves. The scroll wheel 135 is rotatably connected to the substrate 136, and the rotational information is transmitted to the substrate 136. The scroll wheel 135 has a roller shape, and forms a curved shape similar to the forefront 151b of the palm rest 150. As shown in FIG. 2, the wheel 135 retreats from the block 132. This configuration prevents a catch and resultant malfunction of the wheel 135.

The pointing-device substrate 136 has an approximately rectangular shape having a notch 136a, and is provided with a pair of switches 137a and 137b. The switch 137a turns on when the left click button 133 is pressed, and the switch 137b turns on when the right click button 134 is pressed. The touch pad 131 is attached to the center of the substrate 136. The scroll wheel 135 and part of the lock mechanism 140, which will be described later, are arranged in the notch 136a.

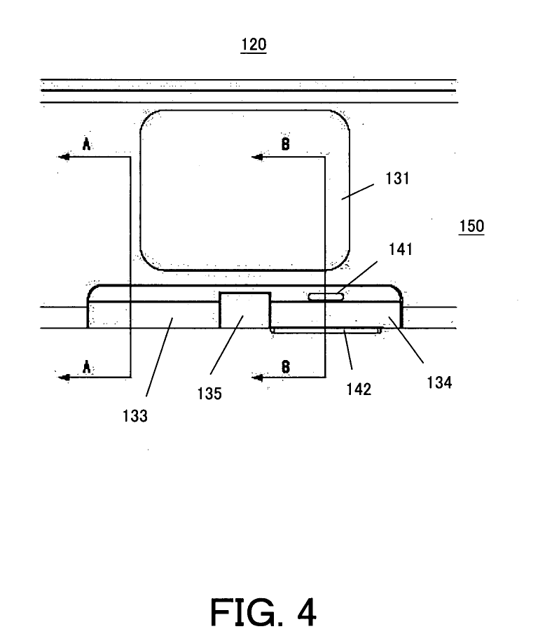

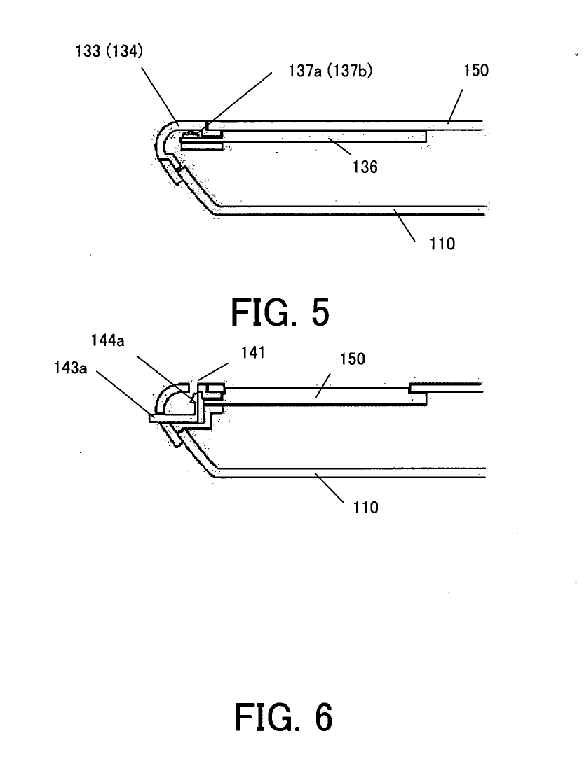

FIG. 4 is a top view of the pointing device 130. FIG. 5 is a sectional view taken along a line A-A, showing that the click button is pressed and the switch turns on. The switches 137a and 137b have the same structure, and may apply any structure known in the art. For example, each of the switches 137a and 137b may be configured so that when the click button pressed down, its central elevating projection is electrified.

The lock mechanism 140 provides opening and closing between the base 110 and the LCD bezel frame 190, and locks and unlocks the folded LCD bezel frame 190 over the base 110. The lock mechanism 140 includes a hook hole 141, an engagement block 142, a forcing member 145, and an engaging part 146.

The hook hole 141 is made in the flat part 134a of the right click button 134, as shown in FIG. 2, and is an approximately rectangular perforation into which the engaging part 146 is inserted and from which the engaging part 146 is ejected. This configuration can make the length of the palm rest 150 in the L direction shorter than the conventional structure that forms the hook hole 141 as a separate member from the click button 134 on the side of the keyboard 120. This configuration enables the keyboard 120 to be spaced from the LCD screen 192, improving the operability of the keyboard 120.

The engagement block 142 has a flat part 143 and an engaging part 144, as shown in FIG. 3. The flat part 143 has a square plate that is movable in the L direction in the engagement space 112 of the base 110. A sidewall 113 restrains a movement of the engagement block 142 in an L₂ direction. The flat part 143 forms, as shown in FIG. 2, the release button 143a that projects from the notch 132b of the block 132. The engaging part 144 has a hook 144a at its tip, and is engaged with the engaging part 146 via the hook 144a, thereby locking the LCD bezel frame 190. When the release button 143a projects, the hook 144a is engaged with the engaging part 146. As a result, the LCD bezel frame 190 is locked while folded over the base 110. On the other hand, when the release button 143a is pressed, the hook 144a is disengaged from the engaging part 146, making the engaging part 146 movable. As a result, the LCD bezel frame 190 is unlocked, and can be unfolded relative to the base 110. FIG. 6 is a sectional view taken along the line B-B, although omitting the forcing member 145.

The forcing member 145 forces the engagement block 142 in the projecting direction or L₁ direction of the release button 143a of the engagement block 142. The forcing member 145 is made, but not limited to, a compression spring, one end of which is attached to the sidewall 113 of the engagement space 112, and the other end of which is attached to the engagement block 142.

As shown in FIG. 1, the engaging part 146 is provided at the center top of the LCD bezel frame 190, and has a similar shape as that of the engaging part 144. A hook of the engaging part 146 opposes to the hook 144a. When the LCD bezel frame 190 is folded over the base 110, the engaging part 146 is inserted into the hook hole 141, and engaged with the engaging part 144 through the hook hole 141. The engaging parts 144 and 146 are arranged on the notch 136a formed on the pointing-device substrate 136. The notch 136a enables the lock mechanism 140 and the click button 134 to be arranged at the same position, and shortens the length of the palm rest 150 in the L direction. Thus, the lock mechanism 140 and the click button 134 share the component mounting space, forming the space for another component.

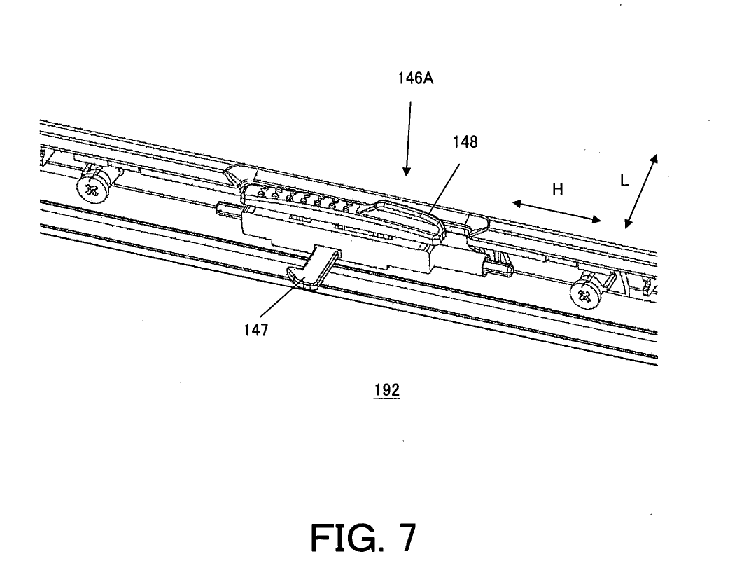

While this embodiment provides the hook 144a to the engagement block 142 so that the hook 144a is movable, the engaging part 146 may be made movable. In addition, while this embodiment moves the hook 144a in the L direction, the hook 144a and the engaging part 146 may be rotated by 90°, and the hook or the engaged part may be moved in a direction orthogonal to the L direction. FIG. 7 shows an embodiment that makes the engaging part 146 movable in the direction orthogonal to the L direction, and more specifically has an engaging part 146A having a hook 147 and a slider 148 movable in the H direction orthogonal to the L direction.

While this embodiment forms the hook hole 141 in the right click button 134, the hook hole 141 may be provided in the left click button 133. In that case, the engagement space 112, the engagement block 142, and the engaging part 146 may be formed on the leftward side to their positions shown in FIG. 1.

The palm rest 150 is a region in front of the keyboard 120, and has no operating part for the palm or wrist to rest. The palm rest 150 maintains the wrists horizontally, and mitigates the fatigue and tenosynovitis due to the long-term typing. The palm rest 150 includes, as shown in FIG. 3, the top surface part 151a and the front edge 151b. A rectangular hole 150a is formed in the top surface part 15la with a center corresponding to the center of the home position of the keyboard 120. An attachment hole 150b is formed in the front edge 151b, and has a center aligned with the center of the rectangular hole 150a. A pair of receptors (not shown) are formed on the rear surface (not shown) of the palm rest 150 shown in FIG. 3, and engaged with the pair of projections 132c movably.

The front edge 151b is formed as an inclined surface or curved surface, and has a residue display 160 on the right end. The front edge 151b enables the user to view the residue display 160 when the LCD bezel frame 190 is both folded over and unfolded from the base 110. In other words, when the user places the laptop PC 100 operably on the desk, he can always view the residue display 160.

The residue display 160 displays the residue of the battery of the laptop PC 100, and includes a built-in secondary battery, a detector that detects the voltage and current of the battery, a controller, five LED lamps 162, and an operation button 164 integrated with the LED lamps 162. The controller calculates the residue of the battery based on a detection result by the detector when the operation button 164 is pressed, and turns on plural LED lamps 162 for a limited time period, the number of which corresponds to the residue. The residue display 160 uses plural LED lamps 162, and displays the residue by stages, enabling the user to recognize the residue at a glance. The residue display 160 turns on the LED lamps 162 for the limited time period for energy saving when necessary (or when the operation button 164 is pressed down) rather than normally turning on. The number of batteries may be plural.

This embodiment provides the power button 170 at the upper right part of the top surface of the base 110, but this arrangement is merely illustrative. The laptop PC 100 of this embodiment arranges the keyboard 120 closer to the user, and effectively utilizes the vacant space.

The LCD screen 192 is provided to the LCD bezel frame 190. The LCD bezel frame 190 has a substantially rectangular shape that holds the LCD screen 192.

In operation, the user inputs information with the keyboard 120 and the pointing device 130. This embodiment makes the length of the palm rest 150 in the L direction shorter than ever, and separates the keyboard 120 by that length from the LCD screen 192 in the L₁ direction, improving the operability.

The palm rest 150 is shortened in the L direction because 1) the flat parts 133a and 134a of the click buttons 133 and 134 are shorter in the L direction than the conventional click buttons, and 2) the pointing device 130 and the lock mechanism 140 are located at the same position. In order to realize the first configuration and maintain the operability of the click buttons 133 and 134, the curved parts 133b and 134b that extend to the front edge 151b are connected to the flat parts 133a and 134a so as to maintain the conventional sizes for the click buttons 133 and 134. In order to realize the second configuration, the notch 136a is formed in the pointing-device substrate 136 so that the substrate 136 does not collide with the lock mechanism 140. In addition, the notch 132b is formed in the block 132 so as to allow the projection of the release button 143a.

The scroll wheel 135 enhances the operability of the pointing device 130. In this case, the scroll wheel 135 is provided at the front edge 151b, and has a roller or curved shape corresponding to the shape of the front edge 151b so as to prevent the malfunction due to unnecessary catches.

After the information input ends, the LCD bezel frame 190 is folded over the base 110. In this case, the engaging part 146 is inserted into the hook hole 141, and engaged with the hook 144a. As a result, the folded LCD bezel frame 190 is locked by the base 110.

In using the laptop PC 100 again, the user presses the release button 143a and unlocks the LCD bezel frame 190 from the base 110. Thereby, the user can unfolds the LCD bezel frame 190 from the base 110. If necessary, a popup structure may be used, which provides the hinge 102 with the torque in advance, and slightly unfolds the LCD bezel frame 190 from the base 110 when the release button 143a is pressed. After the LCD bezel frame 190 is developed, the user presses the power switch 170, and runs the operation system.

The present invention thus can provide an electronic apparatus having a pointing device with good information input operability.

Further, the present invention is not limited to these preferred embodiments, and various variations and modifications may be made without departing from the scope of the present invention.

What is claimed is:

1. An electronic apparatus comprising:
a body, and a display that displays information and is foldable over the body;
a pointing device that designates an input position and coordinate on the display; and
a lock mechanism that locks the display that has been folded over the body, part of said lock mechanism being formed in said pointing device.

2. An electronic apparatus according to claim 1, wherein said pointing device includes an operation button, and said lock mechanism includes:
a first engaging part provided on said display;
an engagement hole formed in the operation button in said body and, the first engaging part being inserted into the engagement hole; and
a second engaging part configured to be engageable with and disengageable from the first engaging part that is inserted into the engagement hole.

3. An electronic apparatus according to claim 2, wherein said lock mechanism further includes a release button, coupled to the operation button, which moves the second engaging part for a disengagement from the first engaging part that is inserted into the engagement hole.

4. An electronic apparatus according to claim 2, wherein said pointing device includes a pair of operation buttons, and a wheel arranged between the pair of operation buttons.

5. An electronic apparatus according to claim 4, wherein the wheel has a roller shape.

6. An electronic apparatus according to claim 2, wherein said pointing device further includes a substrate having a notch in which the first and second engaging parts are arranged.

7. An electronic apparatus according to claim 2, wherein said pointing device further includes a touch pad between the operation button and said display, and said electronic apparatus further comprises a keyboard between the touch pad and said display.

8. An electronic apparatus comprising:
a body, and a display that displays information and is foldable over the body; and
a pointing device that designates an input position and coordinate on the display, and includes an operation button that is formed at a front edge as a corner of said body opposite to said display, the operation button at least partially exposing while said display is folded.

9. An electronic apparatus according to claim 8, wherein said pointing device includes a pair of operation buttons, and a wheel arranged between the pair of operation buttons, the wheel being formed on the front edge, and at least partially exposing while said display is folded.

10. An electronic apparatus according to claim 9, wherein the front edge has a curved shape.

11. An electronic apparatus according to claim 9, wherein the wheel has a roller shape.

12. An electronic apparatus according to claim 8, wherein said pointing device further includes a touch pad between the operation button and said display, and said electronic apparatus further comprises a keyboard between the touch pad and said display.
